(19) United States
(12) Patent Application Publication
(10) Pub. No.: US 2006/0190824 A1
(43) Pub. Date: Aug. 24, 2006

(54) Systems and methods for sharing screen-saver content

(75) Inventors: Louis J. Montulli, Reno, NV (US); James H. Clark, Redwood City, CA (US); Jeffrey N. Whitehead, San Jose, CA (US); Jason F. Harrison, San Jose, CA (US); Aleksander K. Totic, San Francisco, CA (US); Garrett A. Blythe, Cupertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,263

(22) Filed: Feb. 23, 2005

(51) Int. Cl. G06F 17/00; G06F 17/30; G06F 15/16; G06F 17/21

(52) U.S. Cl. 715/731; 715/867; 707/3; 709/217; 715/500.1

(57) ABSTRACT

Systems and methods are disclosed for distributing content by automatically selecting one or more images as a multimedia presentation based on one or more criteria; and automatically disseminating the multimedia presentation to one or more subscribers.

### BACKGROUND

Traditionally, a display device of choice for desktop or countertop computing systems is the conventional cathode ray tube. When an unchanging pattern is displayed on a cathode ray tube for extended periods of time, a phenomena called “burn-in” occurs and damages the screen phosphors, resulting in a degradation of contrast and brightness in those areas of the cathode ray tube (CRT) subjected to the continuous display of an unchanging pattern. Similarly, display devices such as liquid crystal displays (either active or passive matrix) experience a similar degradation in performance when subjected to the continuous display of an unchanging pattern. Consequently, the idea of a “screen saver” was developed.

As noted in U.S. Pat. Nos. 6,374,145 and 6,256,008, screen savers can be classified in two primary groups. The first group comprises those screen savers that completely blank the display area by removing all signals from the display device, resulting in a blank display. A second group of screen savers operates by animating a continuously changing pattern on the screen or display device during that period in which the computer is idle, e.g., when a user walks away from their desk. Screen savers have also been used to implement rudimentary security, e.g., once the screen saver display begins or the CRT is blanked, interaction with the computer is prevented until a user successfully enters a password. After entry of the correct password, the screen saver is disabled the computer returns to normal operation. Additionally, the screen saver function may be invoked by either a user supplied command or a default or programmable system time-out. For example, software from AfterDark displayed images already present on the user's computer while software from PointCast would “push” out information such as sports scores, stock quotes, and news information, which would be displayed via screen saver.

On a parallel note, U.S. Pat. No. 6,133,985 discloses a method for processing at least one digital image of at least one photographic image and distributing at least one visual print produced from the at least one digital image. The method includes the steps of storing at least one digital image of at least one photographic image on at least one image server at a first location. Selective authorized access to the at least one digital image of the at least one photographic image from a second location is then facilitated. Orders are received for at least one visual print of the at least one photographic image from the second location. Based upon the orders at least one visual image is produced from the stored digital image at the first location in response to the at least one order.

### SUMMARY

In one aspect, systems and methods are disclosed for distributing content by automatically selecting one or more images as a multimedia presentation based on one or more criteria; and automatically disseminating the multimedia presentation to one or more subscribers.

In another aspect, systems and methods are disclosed for distributing content with means for automatically selecting one or more images as a multimedia presentation based on one or more criteria; and means for automatically disseminating the multimedia presentation to one or more subscribers.

In yet another aspect, systems and methods are disclosed for distributing content by generating multimedia by a first user and associating a keyword or search parameter with the presentation or content; searching for the multimedia content based on the keyword or parameter; downloading the multimedia presentation to a second user's computer; applying the multimedia presentation as a screen saver for the second user; subsequently modifying the multimedia presentation by the first user; notifying the second user's computer that an updated presentation is available; synchronizing with the second user's computer; and displaying the modified multimedia presentation as the screen saver.

The subsequently modifying the multimedia presentation can include adding one or more new photos and the displaying the modified multimedia presentation can show the new photos as part of the screen saver.

Advantages of the system may include one or more of the following. The system enables multimedia content to be shared easily among a number of users as screen savers. The system enables easy content selection. For example, the user can say “send all photos with the keyword “daughter” to the user's mother. That way, as new photos were added, they would automatically be distributed to the user's mother. Moreover, any changes can be effected quickly and conveniently. The changes are distributed over the Internet or suitable wide area network so that cost is minimized and delivery is nearly instantaneous.

### BRIEF DESCRIPTION OF THE DRAWINGS

Further features and other objects and advantages of this invention will become clear from the following detailed description made with reference to the drawings in which:

FIGS. 1-3 show exemplary processes that provide the ability for two or more computers to share a multimedia presentation over a network.

### DESCRIPTION

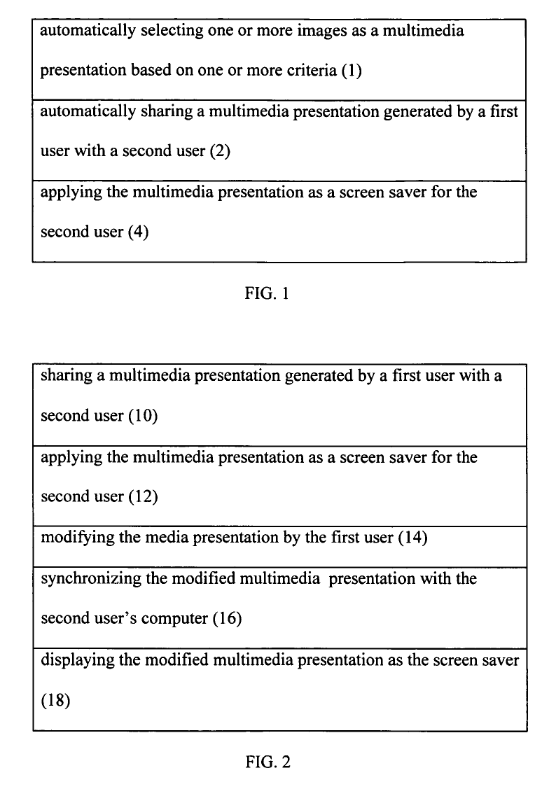

FIGS. 1-2 show exemplary processes that provide the ability for two (or more) computers to share a multimedia presentation over a network. The presentation can be pictures or slideshows, such that the recipient of the share can be automatically updated and the media presentation can be used a screensaver.

The process of FIG. 1 includes automatically selecting one or more images as a multimedia presentation based on one or more criteria such as one or more keywords (1); automatically sharing a multimedia presentation generated by a first user with a second user (2); and applying the multimedia presentation as a screen saver for the second user (4). In one embodiment, the first user (content producer) acquires digital images by scanning or acquired directly from a digital camera of a type well known in the art. The acquired digital images are then transferred electronically to one or more machines at a first location, e.g., computers, for storage as well known in the art. The digital images may be transferred by the user to a server through an upload process. The server stores the digital images in a commercially available database on a RAID disk partition to guard against disk failures, and the server data is archived on an archival medium (such as an 8 mm. tape drive) at regular intervals to guard against catastrophic failures.

In another embodiment, the digital images are accessed at the server through the use HyperText Markup Language (HTML) pages on the WWW (World Wide Web) or a client interface accessing an image server using a proprietary protocol over a computer network such as the Internet. The user can access HTML pages from a WWW browser using either the Secure HyperText Transport Protocol (HTTPS) or HyperText Transport Protocol (HTTP) to access the server. The server is configured with an HTML forms interface which provides access to thumbnails (small replicas of the full digital image) of the images in response to a search query or parameter. The first user can electronically mail (e-mail) an image to another party; download an image, order a visual print of a specific image in a variety of formats and sizes, such as photographic prints or enlargements of photographic prints, and photographic merchandise including T-shirts, sweatshirts, mugs, mouse pads, puzzles, ties, buttons, electronic slide shows, and other items bearing the digital image. The user can also share the images with the second user. In one embodiment, to share the images, the user selects the images to be shared, selects recipients to receive the shared images, and sends an invitation to each recipient. In response, the recipient can accept or reject the shared images. If accepted, the images are downloaded to the user's local computer. Next, the software updates the second user's computer to reflect the newly downloaded images are to be used as screen savers. Alternatively, the user can manually select the shared images as images for screen saver as follows. The user opens Display in Window's Control Panel. On the Screen Saver tab, under Screen saver, the user clicks My Pictures Slideshow in the list. The Settings tab is used to specify the folder containing the shared pictures, define picture size, and set other options. After specifying a screen saver, the second user's computer will automatically start when it is idle for the number of minutes specified in the Wait tab.

FIG. 2 shows a second embodiment for content distribution. The process of FIG. 2 includes sharing a multimedia presentation generated by a first user with a second user (10). The process applies the multimedia presentation as a screen saver for the second user (12). Subsequently, the first user modifies the multimedia presentation by the first user (14). The updated presentation is synchronized with the second user's computer (16). The process then displays the modified multimedia presentation as the screen saver (18).

In one exemplary operation, a user shares a photo album with his/her mother. The mother accepts the share and tells the program that she would like to use that share as her screen saver. Now, whenever the user updates the photo album, his/her mother's album will be automatically updated and the screen saver is then updated.

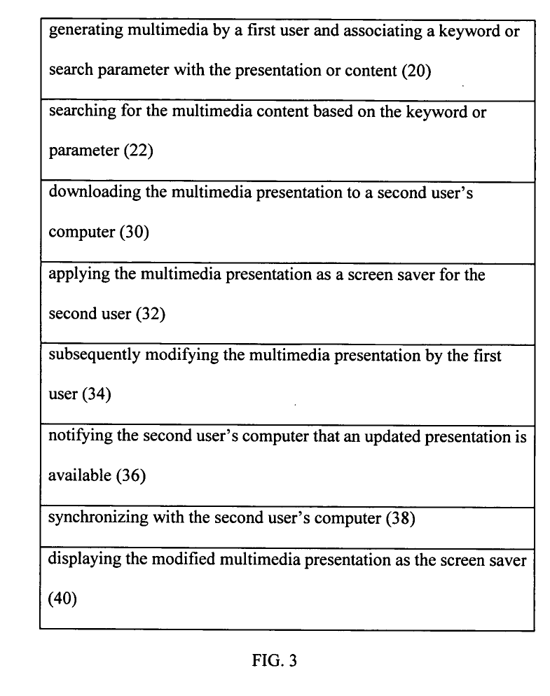

FIG. 3 shows a third exemplary process that supports screen saver with picture slide show in which is published by a content producer and subscribed/distributed based on a keyword or search parameter. The process of FIG. 3 includes generating multimedia by a first user (or content producer) and associating a keyword or search parameter with the presentation or content (20). A second user (content consumer) can search for the multimedia content based on the keyword or parameter (22); download the multimedia presentation to a second user's computer (30); and apply the multimedia presentation as a screen saver for the second user (32). Subsequently, the first user can modify the multimedia presentation by the first user (34). The system notifies the second user's computer that an updated presentation is available (36); and upon user acceptance, synchronizes with the second user's computer (38) to update the content. Next, the system displays the modified multimedia presentation as the screen saver (40) Computer programs designed for use in office environments commonly display a password dialog box as a part of the screen saver image or as a stand-alone function. Password protection advantageously safeguards sensitive information held within a computer system during intermediate periods of time when the user has left the work area. Password protection with user inactivity activation allows the worker to leave the work area without needing to log out of a session with the computer. This increases security, because the user will often neglect to log out of the computer when leaving the work area to attend a meeting, eat lunch or perform other tasks away from the work area. On the other hand, the user may desire to log out of the computer session at the end of the workday.

In one embodiment, the screen savers and a password protection program can be activated by sensing a period of user inactivity. One method of controlling computer program activation is to use a timer. The timer is reset when an input is detected from the keyboard or the mouse. The timer is essentially a counter which counts for a predetermined number of clock cycles. After the timer has reached a predetermined count, the timer is said to “time-out.” Typically, the timer generates a “time-out signal” upon time-out. The amount of time required for the timer to produce the time-out signal is called a “time-out period.” Often the time-out signal is coupled to provide an interrupt to a central processing unit within the computer. When the time-out signal is detected, an interrupt request signal is provided to the central processing unit which in turn activates the screen saver and/or password protection program. Once the timer begins counting, if the user provides another input via the keyboard or the mouse, the timer is reset and begins counting anew. Thus the screen saver and/or password protection program will not be activated when the user is actively working with the computer. The screen saver and/or password protection program will only be activated after the user has remained inactive for the duration of the prespecified time-out period.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. For example, although the buffer memory is described as high speed static random access memory (SRAM), the memory can be any suitable memory, including DRAM, EEPROMs, flash, and ferro-electric elements, for example. The invention may be implemented in digital electronic circuitry or in computer hardware, firmware, software, or in combinations of them.

Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for distributing content, comprising:
automatically selecting one or more images as a multimedia presentation based on one or more criteria; and
automatically disseminating the multimedia presentation to one or more subscribers.

2. The method of claim 1, wherein one of the criteria comprises a keyword.

3. The method of claim 1, comprising applying the multimedia presentation as a screen saver for the second user.

4. The method of claim 1, comprising updating the media presentation by the first user.

5. The method of claim 1, comprising notifying the second user that the multimedia presentation has been updated.

6. The method of claim 1, comprising modifying the multimedia presentation by the first user.

7. The method of claim 6, comprising synchronizing the modified multimedia presentation with the second user's computer.

8. The method of claim 1, comprising storing the multimedia presentation with a searchable parameter.

9. The method of claim 1, comprising searching for the multimedia presentation based on a search parameter.

10. A system for distributing content, comprising:
means for automatically selecting one or more images as a multimedia presentation based on one or more criteria; and
means for automatically disseminating the multimedia presentation to one or more subscribers.

11. The system of claim 10, wherein one of the criteria comprises a keyword.

12. The system of claim 10, comprising means for applying the multimedia presentation as a screen saver for the second user.

13. The system of claim 10, comprising means for updating the media presentation by the first user.

14. The system of claim 10, comprising means for notifying the second user that the multimedia presentation has been updated.

15. The system of claim 10, comprising means for modifying the multimedia presentation by the first user.

16. The system of claim 15, comprising synchronizing the modified multimedia presentation with the second user's computer.

17. The system of claim 10, comprising storing the multimedia presentation with a searchable parameter.

18. The system of claim 10, comprising searching for the multimedia presentation based on a search parameter.

19. A method for distributing content, comprising:
generating multimedia by a first user and associating a keyword or search parameter with the presentation or content;
searching for the multimedia content based on the keyword or parameter;
downloading the multimedia presentation to a second user's computer;
applying the multimedia presentation as a screen saver for the second user;
subsequently modifying the multimedia presentation by the first user;
notifying the second user's computer that an updated presentation is available;
synchronizing with the second user's computer; and
displaying the modified multimedia presentation as the screen saver.

20. The method of claim 19, wherein the subsequently modifying the multimedia presentation comprises adding one or more new photos and wherein the displaying the modified multimedia presentation comprises showing the new photos with the screen saver.
